(19) United States
(12) Patent Application Publication
(10) Pub. No.: US 2025/0219793 A1
(43) Pub. Date: Jul. 3, 2025

(54) PDCCH AND CSI-RS RECEPTION IN MULTI-TRP SCENARIO WITH UNIFIED TCI FRAMEWORK

(71) Applicant: LENOVO (BEIJING) LIMITED, Beijing (CN)

(72) Inventors: Bingchao LIU, Beijing (CN); Chenxi ZHU, Fairfax, VA (US); Lingling XIAO, Beijing (CN); Wei LING, Beijing (CN); Yi ZHANG, Beijing (CN)

(21) Appl. No.: 18/852,192

(22) PCT Filed: Mar. 31, 2022
(86) PCT No.: PCT/CN2022/084325

§ 371 Date: Sep. 27, 2024

(51) Int. Cl. H04L 5/00; H04W 72/23

(52) U.S. Cl. CPC H04L 5/0053; H04W 72/23

(57) ABSTRACT

Methods and apparatuses for PDCCH and CSI-RS reception in multi-TRP scenario with unified TCI framework are disclosed. In one embodiment, a UE comprises a transceiver; and a processor coupled to the transceiver, wherein the processor is configured to receive, via the transceiver, a medium access control (MAC) control element (CE) activating at least one Transmission Configuration Indication (TCI) codepoint with two downlink (DL) or joint TCI states; and receive, via the transceiver, a downlink control information (DCI) indicating one TCI codepoint being activated with two DL or joint TCI states if multiple TCI codepoints are activated with DL or joint TCI states.

### FIELD

The subject matter disclosed herein generally relates to wireless communications, and more particularly relates to methods and apparatuses for PDCCH and CSI-RS reception in multi-TRP scenario with unified TCI framework.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit

(CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Shared Channel (PUSCH), Downlink Control Information (DCI), transmission reception point (TRP), Sounding Reference Signal (SRS), Medium Access Control (MAC), MAC control element (MAC CE), Physical Uplink Control Channel (PUCCH), Transmission Configuration Indicator (TCI), Radio Resource Control (RRC), Physical Downlink Control Channel (PDCCH), TS (Technical Specification) (TS refers to 3GPP Technical Specification in this disclosure), Pathloss reference signal (PL-RS), quasi-colocation (QCL), reference signal (RS), Physical Downlink Shared Channel (PDSCH), component carrier (CC), control resource set (CORESET), codebook (CB), non-codebook (nCB), band width part (BWP), dynamic grant (DG), configured grant (CG), SRS resource set indication (SRSI), Demodulation Reference Signal (DMRS), Channel State Information Reference Signal (CSI-RS), Frequency range 1 (FRI, 410 MHz˜7125 MHZ), Frequency range 2 (FR2, 24250 MHz˜52.6GHZ).

Multi-TRP based DL operation was introduced in NR Release 16 by means of multi-DCI based multi-TRP PDSCH transmission as well as single-DCI based multi-TRP PDSCH operation. For multi-DCI based multi-TRP, each TRP independently sends DCI scheduling PDSCH transmission from the corresponding TRP. A UE may receive multiple DCIs from different TRPs in a slot scheduling multiple fully-overlapped or partially-overlapped or non-overlapped PUSCH transmissions in another slot. For single-DCI based multi-TRP, one TRP may send a DCI scheduling one or multiple PDSCH transmissions from one or multiple TRPs. Only one DCI can be transmitted in one slot from a TRP. Furthermore, single frequency network (SFN) based PDCCH and PDSCH transmissions were specified in NR Release 17 to improve the reliability of PDCCH and PDSCH for high speed train scenario. For SFN scheme, a same DCI or PDSCH is transmitted by different TRPs on a same set of frequency-time domain resources by using different beams in FR2.

When SFN PDCCH scheme is configured for a BWP of a cell in multi-TRP scenario, each PDCCH can be transmitted by different TRPs with different beams by using a same set of frequency-time resources. FIG. 1 illustrates an example that a CORESET is transmitted with SFN manner. The PDCCH in the CORESET is simultaneously transmitted by TRP1 and TRP2 by using Beam 1 and Beam 2, respectively. It means that the PDCCH in the CORESET is transmitted by TRP1 with Beam 1, and is also transmitted by TRP2 with Beam 2. Beam 1 and Beam 2 are indicated by two TCI states applied to the CORESET.

All multi-TRP based DL transmission schemes in NR Release 16 and NR Release 17 are based on TCI framework specified in NR Release 15. For example, the TCI state for PDCCH reception is configured per CORESET by MAC CE.

In order to reduce the beam indication overhead, unified TCI framework was specified in NR Release 17 for single-TRP operation. A unified TCI state is shared for all UE dedicated PDCCH.

This disclosure targets the PDCCH and CSI-RS reception in multi-TRP scenario with unified TCI framework with multiple indicated TCI states.

### BRIEF SUMMARY

Methods and apparatuses for PDCCH and CSI-RS reception in multi-TRP scenario with unified TCI framework are disclosed.

In one embodiment, a UE comprises a transceiver; and a processor coupled to the transceiver, wherein the processor is configured to receive, via the transceiver, a medium access control (MAC) control element (CE) activating at least one Transmission Configuration Indication (TCI) codepoint with two downlink (DL) or joint TCI states; and receive, via the transceiver, a downlink control information (DCI) indicating one TCI codepoint being activated with two DL or joint TCI states if multiple TCI codepoints are activated with DL or joint TCI states.

In some embodiment, the processor is further configured to determine, for PDCCH reception, one of or both a first TCI state and a second TCI state of the two DL or joint TCI states activated to the only one activated TCI codepoint or the indicated one TCI codepoint. In particular, depending on CORESET ID of a CORESET for PDCCH reception and/or search space(s) associated with the CORESET, one of or both the first TCI state and the second TCI state are determined for PDCCH reception from the CORESET.

In some embodiment, if SFN scheme is configured in a BWP of a cell, for CORESET with index 0, a configured higher layer parameter in the CORESET with index 0indicates the first TCI state or the second TCI state or both the first TCI state and the second TCI state are applied to DMRS port of PDCCH from the CORESET with index 0, and if no higher layer parameter is configured to indicate the TCI state for PDCCH from the CORESET with index 0, a second MAC CE indicates one or two DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, both the first TCI state and the second TCI state are applied to the DMRS port of the PDCCH from the first CORESET with index other than 0; for a second CORESET with index other than 0 associated only with CSS other than Type3-PDCCH CSS sets, the first TCI state or both the first TCI state and the second TCI state are applied to the DMRS port of the PDCCH from the second CORESET with index other than 0; and for a third CORESET with index other than 0 associated with both USS and/or Type3-PDCCH CSS sets and CSS other than Type3-PDCCH CSS sets, both the first TCI state and the second TCI state are applied to the PDCCH in USS and/or Type3-PDCCH CSS sets from the third CORESET with index other than 0 and the first TCI state is applied to the PDCCH in CSS other than Type3-PDCCH CSS sets from the third CORESET with index other than 0, or both the first TCI state and the second TCI state are applied to the PDCCH in USS and/or Type3-PDCCH CSS sets from the third CORESET with index other than 0 and a configured higher layer parameter indicates the first TCI state or the second TCI state or both the first TCI state and the second TCI state are applied to DMRS port of PDCCH in CSS other than Type3-PDCCH CSS sets from the third CORESET with index other than 0, or a configured higher layer parameter for the third CORESET with index other than 0 indicates the first TCI state or the second TCI state or both the first TCI state and the second TCI state are applied to DMRS port of PDCCH from the third CORESET with index other than 0

In some embodiment, if SFN scheme is not configured in a BWP of a cell, for CORESET with index 0, a configured higher layer parameter for the CORESET with index 0 indicates the first TCI state or the second TCI state is applied to DMRS port of PDCCH from the CORESET with index 0, and if no higher layer parameter is configured to indicate the TCI state for PDCCH from the CORESET with index 0, a second MAC CE indicates one DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, the first TCI state is applied to the DMRS port of the PDCCH from the first CORESET with index other than 0, or a configured higher layer parameter indicates the first TCI state or the second TCI state is applied to the DMRS port of the PDCCH from the first CORESET with index other than 0; for a second CORESET with index other than 0 associated only with CSS other than Type3-PDCCH CSS sets, a configured higher layer parameter for the second CORESET indicates the first TCI state or the second TCI state is applied to the DMRS port of the PDCCH from the second CORESET with index other than 0, and if no higher layer parameter is configured to indicate the TCI state for PDCCH from the second CORESET with index other than 0, a second MAC CE indicates one DL TCI state for the second CORESET with index other than 0; and for a third CORESET with index other than 0 associated with both USS and/or Type3-PDCCH CSS sets and CSS other than Type3-PDCCH CSS sets, the first TCI state is applied to the DMRS port of the PDCCH in USS and/or Type3-PDCCH CSS sets from the third CORESET with index other than 0 and a configured higher layer parameter for the third CORESET indicates the first TCI state or the second TCI state is applied to the DMRS port of the PDCCH in CSS other than Type3-PDCCH CSS sets from the third CORESET with index other than 0, or a configured higher layer parameter for the third CORESET indicates the first TCI state or the second TCI state are applied to PDCCH from the third CORESET with index other than 0.

In some embodiment, the processor is further configured to determine, for CSI-RS resource without configured TCI state or QCL information, one activated TCI state. In particular, for aperiodic CSI-RS resource used for CSI acquisition and beam management, a configured higher layer parameter indicates a first TCI state or a second TCI state of the two DL or joint TCI states activated to the only one TCI codepoint or the indicated one TCI codepoint is applied to the aperiodic CSI-RS resource; and if no higher layer parameter is configured to indicate the TCI state for the aperiodic CSI-RS resource, the first TCI state is applied to the aperiodic CSI-RS resource. For periodic or semi-persistent CSI-RS resource without configured or activated TCI state, the activated DL TCI state with the lowest index is applied for the periodic or semi-persistent CSI-RS resource, or the first DL TCI state activated to the lowest TCI codepoint that is activated with at least one DL TCI state is applied to the periodic or semi-persistent CSI-RS resource.

In some embodiment, the processor is further configured to transmit, via the transceiver, a capability on whether the indicated TCI state can be applied for CORESET with index 0 when SFN scheme is configured.

In another embodiment, a method at a UE comprises receiving a medium access control (MAC) control element (CE) activating at least one Transmission Configuration Indication (TCI) codepoint with two downlink (DL) or joint TCI states; and receiving a downlink control information (DCI) indicating one TCI codepoint being activated with two DL or joint TCI states if multiple TCI codepoints are activated with DL or joint TCI states.

In still another embodiment, a base unit comprises a transceiver; and a processor coupled to the transceiver, wherein the processor is configured to transmit, via the transceiver, a medium access control (MAC) control element (CE) activating at least one Transmission Configuration Indication (TCI) codepoint with two downlink (DL) or joint TCI states; and transmit, via the transceiver, a downlink control information (DCI) indicating one TCI codepoint being activated with two DL or joint TCI states if multiple TCI codepoints are activated with DL or joint TCI states.

In yet another embodiment, a method of a base unit comprises transmitting a medium access control (MAC) control element (CE) activating at least one Transmission Configuration Indication (TCI) codepoint with two downlink (DL) or joint TCI states; and transmitting a downlink control information (DCI) indicating one TCI codepoint being activated with two DL or joint TCI states if multiple TCI codepoints are activated with DL or joint TCI states.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example that a CORESET is transmitted with SFN manner;

FIG. 2 is a schematic flow chart diagram illustrating an embodiment of a method;

FIG. 3 is a schematic flow chart diagram illustrating an embodiment of another method; and

FIG. 4 is a schematic block diagram illustrating apparatuses according to one embodiment.

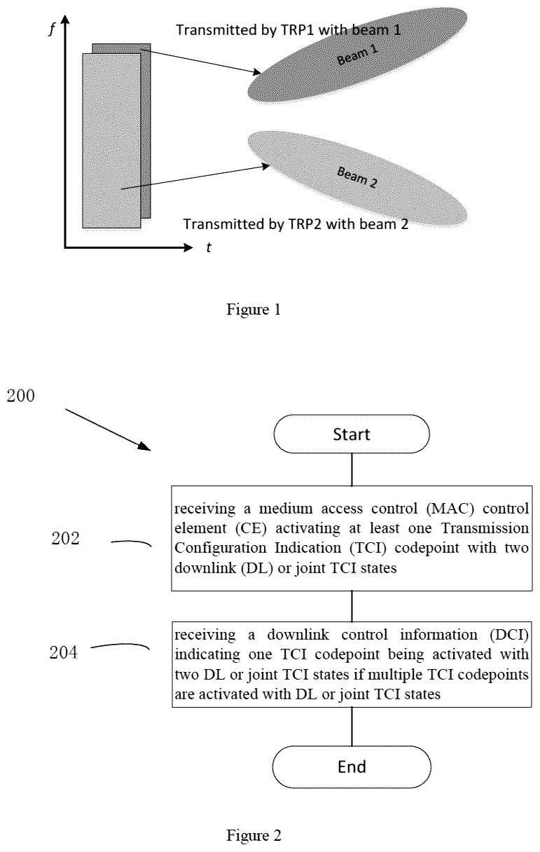

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In NR Release 17 unified TCI framework, joint DL/UL TCI or separate DL/UL TCI can be configured for a cell by RRC signaling.

When separate DL/UL TCI is configured, the DL TCI state for DL reception and UL TCI state for UL transmission are separately indicated. For UL TCI state, the source reference signal in the UL TCI provides a reference for determining UL TX spatial filter at least for dynamic-grant or configured-grant based PUSCH transmission and all of dedicated PUCCH resources, which are the PUCCH resources in RRC-connected mode, in a CC. For DL TCI state, the source reference signal(s) (one source reference signal is contained if only the higher layer parameter qcl-Type1 is configured, and two source reference signals are contained if both the higher layer parameter qcl-Type1 and the higher layer parameter qcl_Type2 are configured) in the DL TCI provides QCL information at least for UE-dedicated reception on PDCCH and the PDSCH receptions in a CC. Each CORESET is configured by a set time-frequency resource for PDCCH reception.

When joint DL/UL TCI is configured, both UL TCI state for UL transmission and DL TCI state for DL reception are determined by a single indicated joint DL/UL TCI state. When the joint DL/UL TCI state is configured, a joint TCI refers to at least a common source reference RS used for determining both the DL QCL information and the UL TX spatial filter. For example, the UL TX beam and the DL RX beam are both determined by the QCL-TypeD RS configured in the indicated joint DL/UL TCI state.

A brief introduction of the TCI state is provided as follows:

The UE can be configured with a list of up to M TCI-State configurations to decode PDSCH according to a detected PDCCH with DCI intended for the UE and the given serving cell, where M depends on the UE capability. The TCI-state is configured by the following RRC signaling:

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Each TCI-State contains parameters for configuring a quasi co-location (QCL) relationship between one or two downlink reference signals and the DMRS ports of the PDSCH, the DMRS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:

‘QCL-TypeA’: {Doppler shift, Doppler spread, average delay, delay spread}

‘QCL-TypeB’: {Doppler shift, Doppler spread}

‘QCL-TypeC’: {Doppler shift, average delay}

‘QCL-TypeD’: {Spatial Rx parameter}

The UE receives an activation command used to map up to 8 TCI states to the codepoints of the DCI field ‘Transmission Configuration Indication’ (TCI field) in one DL BWP of a serving cell for single-TRP scenario. When a UE supports two TCI states in a codepoint of the DCI field ‘Transmission Configuration Indication’ to determine different TX beams for UL transmission, the UE may receive an activation command, the activation command is used to map up to 8 combinations of one or two TCI states to the codepoints of the DCI field ‘Transmission Configuration Indication’, where the one or two TCI states are both used for UL TX beam determination.

To support single-DCI multi-TRP based DL transmission, when separate DL/UL TCI is configured, the DL TCI state activation/deactivation MAC CE and/or UL TCI state activation/deactivation can map up to two DL TCI states and/or up to two UL TCI states to a TCI codepoint contained in DCI format 1_1 or 1_2, which can be used for DL scheduling. When joint DL/UL TCI is configured, the joint TCI state activation/deactivation MAC CE can map up to two joint DL/UL TCI states to a TCI codepoint contained in DCI format 1_1 or 1_2. The TCI codepoint that is mapped with at least one TCI state (DL TCI state, or UL TCI state or joint TCI state) is referred to be activated, and the DL TCI state, or UL TCI state or joint TCI state mapped to the codepoint is referred to be activated.

If a TCI codepoint is mapped with one UL TCI state and one DL TCI state, and the TCI codepoint is indicated by DCI format 1_1 or 1_2 or is the only TCI codepoint activated by DL or joint TCI state activation/deactivation MAC CE, the one UL TCI state shall be applied to all PUSCH, PUCCH and aperiodic SRS resources without configured TCI state, and the DL TCI state shall be applied to part of CORESETs and part of PDSCH receptions.

If a TCI codepoint is mapped with two DL or joint TCI states (e.g. first DL or joint TCI state and second DL or joint TCI state) and the TCI codepoint is indicated by DCI format 1_1 or 1_2 or is the only TCI codepoint activated by DL or joint TCI state activation/deactivation MAC CE, which one of the two DL or joint TCI states or both DL or joint TCI states (i.e. the first DL or joint TCI state, or the second DL or joint TCI state, or both the first DL or joint TCI state and the second DL or joint TCI state) are applied to which CORESET or CSI-RS resource is discussed in this disclosure.

In the following description, to support single-DCI based multi-TRP DL transmission, it is assumed that at least one TCI codepoint is activated and mapped with two DL or joint TCI states and is referred to the activated or indicated TCI codepoint. The one TCI codepoint being activated with two DL or joint TCI states means that a DL or joint TCI state activation/deactivation MAC CE only activates one TCI codepoint, e.g. maps two DL or joint TCI states to the one TCI codepoint. The one TCI codepoint being indicated with two DL or joint TCI states means that a DL or joint TCI state activation/deactivation MAC CE activates two or multiple TCI codepoints, e.g. maps two DL or joint TCI states to at least one of the two or multiple TCI codepoints, while a DCI with format 1_1 or 1_2 indicates one TCI codepoint that is mapped with two DL or joint TCI states. The two DL or joint TCI states mapped to (or activated to) the activated or indicated TCI codepoint can be referred to as activated or indicated two DL or joint TCI states, and are further described as “first TCI state” and “second TCI state”, where, the first TCI state refers to a first TCI state of the activated or indicated two DL or joint TCI states, and the second TCI state refers to a second TCI state of the activated or indicated two DL or joint TCI states, unless they are further limited.

This disclosure proposes the determination of one of or both the first TCI state and the second TCI state to PDCCH reception when the first TCI state and the second TCI state are mapped to the activated or indicated TCI codepoint, and the determination of one of first TCI state and the second TCI state to CSI-RS resource without configured TCI state.

A UE can be configured with up to 4 BWPs in a cell. Up to 3 CORESETs can be configured in a BWP if the higher layer parameter coresetPoolIndex, which is used for TRP differential in multi-DCI based multi-TRP mode, is not configured in each CORESET or a same value of coresetPoolIndex is configured for all CORESETs. Each CORESET is consisted of a set of frequency-time resources for PDCCH reception. Each CORESET is associated with one or more search spaces. The UE shall monitor PDCCH per search space. A search space is a set of candidate control channels formed by CCEs (Control Channel Elements) at a given aggregation level, which the UE is supposed to decode, where a CCE is a number of RB (resource block) groups in a CORESET. The search space can be UE-specific search space (USS), which is a search space dedicated for a UE, or common search space (CSS), which is a search space for a group of UEs. The following types of CSS are supported:

Type0-PDCCH CSS set, Type0A-PDCCH CSS set, and Type0B-PDCCH CSS set: they are used to monitor system information. Different CSS types are used for different types of system information.

Type1-PDCCH CSS set and Type 1A-PDCCH CSS set: they are used for random access procedure.

Type2-PDCCH CSS set and Type2A-PDCCH CSS set: they are used for paging.

Type3-PDCCH CSS set: it is used for group common PDCCH reception.

Type0-PDCCH CSS set, Type0A-PDCCH CSS set, Type0B-PDCCH CSS set, Type 1-PDCCH CSS set, Type 1A-PDCCH CSS set, Type2-PDCCH CSS set and Type2A-PDCCH CSS set are monitored by all the UEs in a cell. Type3-PDCCH CSS set is monitored by a group of UEs in a cell.

The group of UEs shall monitor a Type3-PDCCH CSS using a same beam which is usually the same as that used for monitoring USS. So, in this disclosure, Type3-PDCCH CSS set and USS are classified in one SS category (e.g. SS category #1), while CSS other than Type3-PDCCH CSS sets (i.e. Type0-PDCCH CSS set, Type0A-PDCCH CSS set, Type0B-PDCCH CSS set, Type1-PDCCH CSS set, Type1A-PDCCH CSS set, Type2-PDCCH CSS set and Type2A-PDCCH CSS set) are classified in another SS category (e.g. SS category #2).

As mentioned above, there are three CORESETs: for example, CORESET #0 (CORESET with index 0), CORESET #1 (CORESET with index 1) and CORESET #2 (CORESET with index 2). The UE can only monitor CORESET #0 during initial access procedure to obtain system information. CORESET #1 and CORESET #2 can be referred to as CORESET other than CORESET #0 (CORESET with index other than 0). There are two SS categories: SS category #1 (Type3-PDCCH CSS set and USS) and SS category #2 (CSS other than Type3-PDCCH CSS sets: Type0-PDCCH CSS set, Type0A-PDCCH CSS set, Type0B-PDCCH CSS set, Type 1-PDCCH CSS set, Type1A-PDCCH CSS set, Type2-PDCCH CSS set and Type2A-PDCCH CSS set).

CORESET other than CORESET #0 can be associated with USS and/or CSS. For example, CORESET other than CORESET #0 associated with SS category #1 means that CORESET other than CORESET #0 associated with Type3-PDCCH CSS set and/or USS. CORESET other than CORESET #0 associated with SS category #2 means that CORESET other than CORESET #0 associated with at least one of CSS other than Type3-PDCCH CSS sets (i.e. at least one Type0-PDCCH CSS set, Type0A-PDCCH CSS set, Type0B-PDCCH CSS set, Type1-PDCCH CSS set, Type 1A-PDCCH CSS set, Type2-PDCCH CSS set and Type2A-PDCCH CSS set).

If a DL TCI state (or joint TCI state) is determined to be applied to a PDCCH, it means that the DMRS port(s) of the PDCCH are QCLed with the DL-RS(s) of the DL or joint TCI state.

A first embodiment is related to the determination of TCI state for PDCCH reception when SFN scheme is configured in a BWP of a cell.

When SFN scheme is configured in a BWP of a cell and two DL or joint TCI states (e.g. first TCI state and second TCI state) are mapped to the one activated or indicated TCI codepoint, the first TCI state and/or the second TCI state are applied to PDCCH from a CORESET depending on different CORESETs or different CORESETs associated with different SS categories.

Case 11: For CORESET #0, the UE is required to report a capability on whether the activated or indicated TCI states can be applied to CORESET #0. The gNB can indicate to the UE whether the UE uses the activated or indicated TCI states for CORESET #0 or not, at least based on the reported capability. For example, if a higher layer parameter (e.g., useFirstIndicatedUnifiedTCI, useSecondIndicatedUnifiedTCI or useBothIndicaedUnifiedTCI) is configured, the gNB indicates to the UE to use the activated or indicated TCI states for CORESET #0. In addition, the configured higher layer parameter indicates whether the first TCI state (e.g. by “useFirstIndicatedUnifiedTCI”) or the second TCI state (e.g. by “useSecondIndicatedUnifiedTCI”) or both the first TCI state and the second TCI state (e.g. by “useBothIndicaedUnifiedTCI”) can be applied to PDCCH from CORESET #0. If none of the above-mentioned higher layer parameters (e.g., useFirstIndicatedUnifiedTCI, use SecondIndicatedUnifiedTCI and useBothIndicaedUnifiedTCI) is configured, the gNB indicates (implies) that the UE does not use the activated or indicated TCI states for CORESET #0. If the gNB indicates that the UE does not use the activated or indicated TCI states for CORESET #0 (e.g. none of the above-mentioned higher layer parameters useFirstIndicatedUnifiedTCI, useSecondIndicatedUnifiedTCI and useBothIndicaedUnifiedTCI is configured), the gNB can indicate one or two DL TCI states or joint TCI states for CORESET #0 by a MAC CE (which is different from the DL or joint TCI state activation/deactivation MAC CE). If no DL or joint TCI state(s) are indicated for CORESET #0 by the MAC CE, the UE applies the SSB obtained in the latest RACH procedure to the DMRS port of PDCCH from CORESET #0.

Case 12: For CORESET other than CORESET #0 (e.g. CORESET #1 or CORESET #2) associated with a search space only in SS category #1 in a CC, i.e. associated only with USS and/or Type3-PDCCH CSS sets in a CC, the UE applies both the first TCI state and the second TCI state to the DMRS port of the PDCCH from this CORESET.

Case 13: For CORESET other than CORESET #0 (e.g. CORESET #1 or CORESET #2) associated with a search space only in SS category #2 in a CC, i.e. associated only with CSS other than Type3-PDCCH CSS sets in a CC, the UE applies the first TCI state to the DMRS port of the PDCCH from this CORESET. Alternatively, the UE applies both the first TCI state and the second TCI state to the DMRS port of the PDCCH from this CORESET.

Case 14: For CORESET other than CORESET #0 (e.g. CORESET #1 or CORESET #2) associated with both SS category #1 (USS and/or Type3-PDCCH CSS sets) and SS category #2 (CSS other than Type3-PDCCH CSS sets) in a CC, three alternatives are provided:

Alternative 141: the UE applies both the first TCI state and the second TCI state to the DMRS port of the PDCCH in USS and/or Type3-PDCCH CSS sets from this CORESET and applies the first TCI state to the DMRS port of the PDCCH in CSS other than Type3-PDCCH CSS sets from this CORESET.

Alternative 142: the UE applies both the first TCI state and the second TCI state to the DMRS port of the PDCCH in USS and/or Type3-PDCCH CSS sets from this CORESET. A higher layer parameter is configured to indicate which TCI state(s) (i.e. the first TCI state or the second TCI state or both the first TCI state and the second TCI state) are applied to the DMRS port of the PDCCH in CSS other than Type3-PDCCH CSS sets from this CORESET.

Alternative 143: a higher layer parameter is configured to indicate which TCI state(s) (i.e. the first TCI state or the second TCI state or both the first TCI state and the second TCI state) are applied to DMRS port of all PDCCHs (in USS and/or Type3-PDCCH CSS sets, and in CSS other than Type3-PDCCH CSS sets) from this CORESET.

An example of the first embodiment is described as follows:

It is assumed that two DL TCI states, e.g. the first TCI state of DL-TCI-State #64 and the second TCI state of DL-TCI-State #85 are mapped to the one indicated or activated TCI codepoint. CORESET #0, CORESET #1 and CORESET #2 are configured for the active BWP of a cell. CORESET #0 is only associated with CSS, CORESET #1 is only associated with USS, CORESET #2 is associated with both CSS other than Type3-PDCCH CSS sets and USS. SFN scheme is configured for the active BWP. The UE reports a capability that the indicated unified TCI states can be used for CORESET #0. A RRC parameter useSecondIndicatedUnifiedTCI is configured for CORESET #0.

CORESET #0 belongs to Case 11. So, the UE assumes the DMRS port of PDCCH from CORESET #0 is QCLed with the DL-RS(s) of DL-TCI-State #85.

CORESET #1 belongs to Case 12. So, the UE assumes the DMRS port of PDCCH from CORESET #1 is QCLed with the DL-RSs of both DL-TCI-State #64 and DL-TCI-State #85.

CORESET #2 belongs to Case 14. If Alternative 142 is adopted, and a RRC parameter use FirstIndictaedUnifiedTCI is configured for CORESET #2, then the UE assumes the DMRS port of PDCCH in USS from CORESET #2 is QCLed with the DL-RSs of both DL-TCI-State #64 and DL-TCI-State #85, and assumes the DMRS port of PDCCH in CSS other than Type3-PDCCH CSS sets from CORESET #2 is QCLed with the DL-RS(s) of DL-TCI-State #64.

A second embodiment is related to the determination of TCI state to PDCCH transmission when SFN scheme is not configured in a BWP of a cell.

When SFN scheme is not configured in a BWP of a cell and two DL or joint TCI states (e.g. first TCI state and second TCI state) are mapped to the one activated or indicated TCI codepoint, the first TCI state and/or the second TCI state are applied to PDCCH from a CORESET depending on different CORESETs, or different CORESETs associated with different SS categories.

Case 21: For CORESET #0, a higher layer parameter (e.g., useFirstIndicatedUnifiedTCI or useSecondIndicatedUnifiedTCI) is configured to indicate which DL TCI state (the first TCI state or the second TCI state) is applied to the DMRS port of the PDCCH. If none of the above-mentioned higher layer parameters (e.g., use FirstIndicatedUnifiedTCI and useSecondIndicatedUnifiedTCI) is configured, the gNB can indicate one DL or joint TCI state for CORESET #0 by a MAC CE (which is different from the DL or joint TCI state activation/deactivation MAC CE). If no DL or joint TCI state is indicated for PDCCH from CORESET #0 by the MAC CE, the UE applies the SSB obtained in the latest RACH procedure to the DMRS port of the PDCCH from CORESET #0.

Case 22: For CORESET other than CORESET #0 (e.g. CORESET #1 or CORESET #2) associated with a search space only in SS category #1 in a CC, i.e. associated only with USS and/or Type3-PDCCH CSS sets in a CC, the UE applies the first TCI state to the DMRS port of the PDCCH from this CORESET. Alternatively, a higher layer parameter can be configured to indicate which TCI state (e.g. the first TCI state or the second TCI state) is applied to the DMRS port of the PDCCH from this CORESET.

Case 23: For CORESET other than CORESET #0 (e.g. CORESET #1 or CORESET #2) associated with a search space only in SS category #2 in a CC, i.e. associated only with CSS other than Type3-PDCCH CSS sets in a CC, a higher layer parameter is configured to indicate which TCI state (e.g. the first TCI state or the second TCI state) is applied to the DMRS port of the PDCCH from this CORESET. If the higher layer parameter is not configured, the UE expects the gNB to indicate a TCI state by MAC CE to this CORESET.

Case 24: For CORESET other than CORESET #0 (e.g. CORESET #1 or CORESET #2) associated with both SS category #1 (USS and/or Type3-PDCCH CSS sets) and SS category #2 (CSS other than Type3-PDCCH CSS sets) in a CC, two alternatives are provided:

Alternative 241: the UE applies the first TCI state to the DMRS port of the PDCCH in USS and/or Type3-PDCCH CSS sets from this CORESET. A higher layer parameter is configured to indicate which TCI state (i.e. the first TCI state or the second TCI state) is applied to the DMRS port of the PDCCH in CSS other than Type3-PDCCH CSS sets from this CORESET.

Alternative 242: a higher layer parameter is configured to indicate which TCI state (i.e. the first TCI state or the second TCI state) is applied to DMRS port of all PDCCHs (in USS and/or Type3-PDCCH CSS sets, and in CSS other than Type3-PDCCH CSS sets) from this CORESET.

An example of the second embodiment is describes as follows:

It is assumed that two DL TCI states, e.g. the first TCI state of DL-TCI-State #64 and the second TCI state of DL-TCI-State #85 are mapped to the one indicated or activated TCI codepoint. CORESET #0, CORESET #1 and CORESET #2 are configured for the active BWP of a cell. CORESET #0 is only associated with non-Type3-PDCCH CSS, CORESET #1 is only associated with USS, CORESET #2 is associated with both CSS and USS. SFN scheme is not configured for the active BWP.

CORESET #0 belongs to Case 21. It is assumed that there is no RRC parameter configured for CORESET #0 to indicate which TCI state can be used for PDCCH from CORESET #0, and no MAC CE is received to activate TCI state for PDCCH from CORESET #0. So, the UE assumes the DMRS port of PDCCH from CORESET #0 is QCLed with the SSB obtained in the latest RACH procedure.

CORESET #1 belongs to Case 22. The UE assumes the DMRS port of PDCCH from CORESET #1 is QCLed with the DL-RS(s) of DL-TCI-State #64.

CORESET #2 belongs to Case 24. If Alternative 241 is adopted, and a RRC parameter useSecondIndicatedUnifiedTCI is configured for PDCCH from CORESET #2, then the UE assumes the DMRS port of PDCCH in USS from CORESET #2 is QCLed with DL-TCI-State #64, and assumes the DMRS port for PDCCH in CSS of CORESET #2 is QCLed with DL-TCI-State #85.

A third embodiment is related to the determination of TCI state to CSI-RS resource without configured TCI state.

For aperiodic CSI-RS for CSI acquisition and beam management, if there is no TCI state or QCL information configured for an aperiodic CSI-RS resource, a higher layer parameter is configured for each CSI-RS resource to indicate the first TCI state or the second TCI state is applied to the reception of the aperiodic CSI-RS resource. If the higher layer parameter is not configured for the aperiodic CSI-RS resource to indicate the TCI state, the first TCI state is applied.

For periodic and semi-persistent CSI-RS resource without configured or activated TCI state, the following two alternatives can be used to determine the applied TCI state.

Alternative 31: if two or more TCI states are activated to TCI codepoint(s) by the unified TCI state activation/deactivation MAC CE, the activated DL TCI state with the lowest DL TCI-State-Id is applied for the periodic and semi-persistent CSI-RS resource.

Alternative 32: if two or more TCI states are activated and mapped to TCI codepoint(s) by the DL or joint TCI state activation/deactivation MAC CE, the first DL TCI state mapped to the lowest TCI codepoint that is activated with at least one DL TCI state is applied to the periodic and semi-persistent CSI-RS resource.

An example of the third embodiment is described as follows:

It is assumed that the following TCI states are mapped to each TCI codepoint activated by the DL or joint TCI state activation/deactivation MAC CE:

TCI codepoint 000: UL-TCI-State #1 & UL-TCI-State #12;

TCI codepoint 001: UL-TCI-State #23;

TCI codepoint 010: UL-TCI-State #32;

TCI codepoint 011: UL-TCI-State #24 and DLorJoint-TCI-State #45 and DLorJoint-TCI-State #50;

TCI codepoint 100: UL-TCI-State #45 and DLorJoint-TCI-State #2;

TCI codepoint 101: UL-TCI-State #55 & UL-TCI-State #60 and DLorJoint-TCI-State #32 & DLorJoint-TCI-State #65;

TCI codepoint 110: DLorJoint-TCI-State #64 & DLorJoint-TCI-State #85;

TCI codepoint 111: DLorJoint-TCI-State #120.

Two DL TCI states, e.g., DLorJoint-TCI-State #64 and DLorJoint-TCI-State #85, are indicated as the DL TCI states (i.e. the first TCI state is DLorJoint-TCI-State #64, and the second TCI state is DLorJoint-TCI-State #85.

For aperiodic CSI-RS without indicated TCI state or QCL information, if a RRC parameter useFirstIndicatedUnifiedTCI is configured, the UE applies DLorJoint-TCI-State #64 to this CSI-RS resource.

For periodic and semi-persistent CSI-RS resource without indicated TCI state or QCL information, if Alternative 31 is adopted, DLorJoint-TCI-State #2, which is the activated DL TCI state with lowest DL-TCI-State-Id, is applied to this CSI-RS resource. When Alternative 32 is adopted, DLorJoint-TCI-State #45, which is the first DL TCI state of lowest TCI codepoint (i.e. TCI codepoint 011, since no DL TCI state is mapped to TCI codepoint 000, 001 or 010) that is mapped with at least one DL TCI state, is applied to this CSI-RS resource.

FIG. 2 is a schematic flow chart diagram illustrating an embodiment of a method 200 according to the present application. In some embodiments, the method 200 is performed by an apparatus, such as a remote unit (e.g. UE). In certain embodiments, the method 200 may be performed by a processor executing program code, for example, a microcontroller, a microprocessor, a CPU, a GPU, an auxiliary processing unit, a FPGA, or the like.

The method 200 is a method of a UE, comprising: 202 receiving a medium access control (MAC) control element (CE) activating at least one Transmission Configuration Indication (TCI) codepoint with two downlink (DL) or joint TCI states; and 204 receiving a downlink control information (DCI) indicating one TCI codepoint being activated with two DL or joint TCI states if multiple TCI codepoints are activated with DL or joint TCI states.

In one embodiment, the method further comprises determining, for PDCCH reception, one of or both a first TCI state and a second TCI state of the two DL or joint TCI states activated to the only one activated TCI codepoint or the indicated one TCI codepoint. In particular, depending on CORESET ID of a CORESET for PDCCH reception and/or search space(s) associated with the CORESET, one of or both the first TCI state and the second TCI state are determined for PDCCH reception from the CORESET.

If SFN scheme is configured in a BWP of a cell, for CORESET with index 0, a configured higher layer parameter in the CORESET with index 0 indicates the first TCI state or the second TCI state or both the first TCI state and the second TCI state are applied to DMRS port of PDCCH from the CORESET with index 0, and if no higher layer parameter is configured to indicate the TCI state for PDCCH from the CORESET with index 0, a second MAC CE indicates one or two DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, both the first TCI state and the second TCI state are applied to the DMRS port of the PDCCH from the first CORESET with index other than 0; for a second CORESET with index other than 0 associated only with CSS other than Type3-PDCCH CSS sets, the first TCI state or both the first TCI state and the second TCI state are applied to the DMRS port of the PDCCH from the second CORESET with index other than 0; and for a third CORESET with index other than 0 associated with both USS and/or Type3-PDCCH CSS sets and CSS other than Type3-PDCCH CSS sets, both the first TCI state and the second TCI state are applied to the PDCCH in USS and/or Type3-PDCCH CSS sets from the third CORESET with index other than 0 and the first TCI state is applied to the PDCCH in CSS other than Type3-PDCCH CSS sets from the third CORESET with index other than 0, or both the first TCI state and the second TCI state are applied to the PDCCH in USS and/or Type3-PDCCH CSS sets from the third CORESET with index other than 0 and a configured higher layer parameter indicates the first TCI state or the second TCI state or both the first TCI state and the second TCI state are applied to DMRS port of PDCCH in CSS other than Type3-PDCCH CSS sets from the third CORESET with index other than 0, or a configured higher layer parameter for the third CORESET with index other than 0 indicates the first TCI state or the second TCI state or both the first TCI state and the second TCI state are applied to DMRS port of PDCCH from the third CORESET with index other than 0.

If SFN scheme is not configured in a BWP of a cell, for CORESET with index 0, a configured higher layer parameter for the CORESET with index 0 indicates the first TCI state or the second TCI state is applied to DMRS port of PDCCH from the CORESET with index 0, and if no higher layer parameter is configured to indicate the TCI state for PDCCH from the CORESET with index 0, a second MAC CE indicates one DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, the first TCI state is applied to the DMRS port of the PDCCH from the first CORESET with index other than 0, or a configured higher layer parameter indicates the first TCI state or the second TCI state is applied to the DMRS port of the PDCCH from the first CORESET with index other than 0; for a second CORESET with index other than 0 associated only with CSS other than Type3-PDCCH CSS sets, a configured higher layer parameter for the second CORESET indicates the first TCI state or the second TCI state is applied to the DMRS port of the PDCCH from the second CORESET with index other than 0, and if no higher layer parameter is configured to indicate the TCI state for PDCCH from the second CORESET with index other than 0, a second MAC CE indicates one DL TCI state for the second CORESET with index other than 0; and for a third CORESET with index other than 0 associated with both USS and/or Type3-PDCCH CSS sets and CSS other than Type3-PDCCH CSS sets, the first TCI state is applied to the DMRS port of the PDCCH in USS and/or Type3-PDCCH CSS sets from the third CORESET with index other than 0 and a configured higher layer parameter for the third CORESET indicates the first TCI state or the second TCI state is applied to the DMRS port of the PDCCH in CSS other than Type3-PDCCH CSS sets from the third CORESET with index other than 0, or a configured higher layer parameter for the third CORESET indicates the first TCI state or the second TCI state are applied to PDCCH from the third CORESET with index other than 0.

In some embodiment, the method further comprises determining, for CSI-RS resource without configured TCI state or QCL information, one activated TCI state. In particular, for aperiodic CSI-RS resource used for CSI acquisition and beam management, a configured higher layer parameter indicates a first TCI state or a second TCI state of the two DL or joint TCI states activated to the only one TCI codepoint or the indicated one TCI codepoint is applied to the aperiodic CSI-RS resource; and if no higher layer parameter is configured to indicate the TCI state for the aperiodic CSI-RS resource, the first TCI state is applied to the aperiodic CSI-RS resource. For periodic or semi-persistent CSI-RS resource without configured or activated TCI state, the activated DL TCI state with the lowest index is applied for the periodic or semi-persistent CSI-RS resource, or the first DL TCI state activated to the lowest TCI codepoint that is activated with at least one DL TCI state is applied to the periodic or semi-persistent CSI-RS resource.

In some embodiment, the method further comprises transmitting a capability on whether the indicated TCI state can be applied for CORESET with index 0 when SFN scheme is configured.

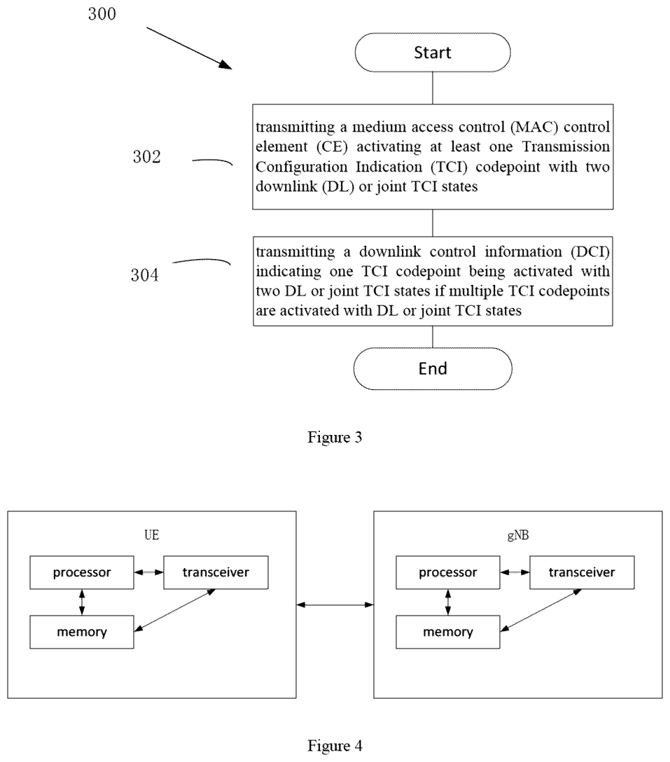

FIG. 3 is a schematic flow chart diagram illustrating an embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may comprise 302 transmitting a medium access control (MAC) control element (CE) activating at least one Transmission Configuration Indication (TCI) codepoint with two downlink (DL) or joint TCI states; and 304 transmitting a downlink control information (DCI) indicating one TCI codepoint being activated with two DL or joint TCI states if multiple TCI codepoints are activated with DL or joint TCI states.

In one embodiment, the method further comprises determining, for PDCCH reception, one of or both a first TCI state and a second TCI state of the two DL or joint TCI states activated to the only one activated TCI codepoint or the indicated one TCI codepoint. In particular, depending on CORESET ID of a CORESET for PDCCH reception and/or search space(s) associated with the CORESET, one of or both the first TCI state and the second TCI state are determined for PDCCH reception from the CORESET.

If SFN scheme is configured in a BWP of a cell, for CORESET with index 0, a configured higher layer parameter in the CORESET with index 0 indicates the first TCI state or the second TCI state or both the first TCI state and the second TCI state are applied to DMRS port of PDCCH from the CORESET with index 0, and if no higher layer parameter is configured to indicate the TCI state for PDCCH from the CORESET with index 0, a second MAC CE indicates one or two DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, both the first TCI state and the second TCI state are applied to the DMRS port of the PDCCH from the first CORESET with index other than 0; for a second CORESET with index other than 0 associated only with CSS other than Type3-PDCCH CSS sets, the first TCI state or both the first TCI state and the second TCI state are applied to the DMRS port of the PDCCH from the second CORESET with index other than 0; and for a third CORESET with index other than 0 associated with both USS and/or Type3-PDCCH CSS sets and CSS other than Type3-PDCCH CSS sets, both the first TCI state and the second TCI state are applied to the PDCCH in USS and/or Type3-PDCCH CSS sets from the third CORESET with index other than 0 and the first TCI state is applied to the PDCCH in CSS other than Type3-PDCCH CSS sets from the third CORESET with index other than 0, or both the first TCI state and the second TCI state are applied to the PDCCH in USS and/or Type3-PDCCH CSS sets from the third CORESET with index other than 0 and a configured higher layer parameter indicates the first TCI state or the second TCI state or both the first TCI state and the second TCI state are applied to DMRS port of PDCCH in CSS other than Type3-PDCCH CSS sets from the third CORESET with index other than 0, or a configured higher layer parameter for the third CORESET with index other than 0 indicates the first TCI state or the second TCI state or both the first TCI state and the second TCI state are applied to DMRS port of PDCCH from the third CORESET with index other than 0.

If SFN scheme is not configured in a BWP of a cell, for CORESET with index 0, a configured higher layer parameter for the CORESET with index 0 indicates the first TCI state or the second TCI state is applied to DMRS port of PDCCH from the CORESET with index 0, and if no higher layer parameter is configured to indicate the TCI state for PDCCH from the CORESET with index 0, a second MAC CE indicates one DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, the first TCI state is applied to the DMRS port of the PDCCH from the first CORESET with index other than 0, or a configured higher layer parameter indicates the first TCI state or the second TCI state is applied to the DMRS port of the PDCCH from the first CORESET with index other than 0; for a second CORESET with index other than 0 associated only with CSS other than Type3-PDCCH CSS sets, a configured higher layer parameter for the second CORESET indicates the first TCI state or the second TCI state is applied to the DMRS port of the PDCCH from the second CORESET with index other than 0, and if no higher layer parameter is configured to indicate the TCI state for PDCCH from the second CORESET with index other than 0, a second MAC CE indicates one DL TCI state for the second CORESET with index other than 0; and for a third CORESET with index other than 0 associated with both USS and/or Type3-PDCCH CSS sets and CSS other than Type3-PDCCH CSS sets, the first TCI state is applied to the DMRS port of the PDCCH in USS and/or Type3-PDCCH CSS sets from the third CORESET with index other than 0 and a configured higher layer parameter for the third CORESET indicates the first TCI state or the second TCI state is applied to the DMRS port of the PDCCH in CSS other than Type3-PDCCH CSS sets from the third CORESET with index other than 0, or a configured higher layer parameter for the third CORESET indicates the first TCI state or the second TCI state are applied to PDCCH from the third CORESET with index other than 0.

In some embodiment, the method further comprises determining, for CSI-RS resource without configured TCI state or QCL information, one activated TCI state. In particular, for aperiodic CSI-RS resource used for CSI acquisition and beam management, a configured higher layer parameter indicates a first TCI state or a second TCI state of the two DL or joint TCI states activated to the only one TCI codepoint or the indicated one TCI codepoint is applied to the aperiodic CSI-RS resource; and if no higher layer parameter is configured to indicate the TCI state for the aperiodic CSI-RS resource, the first TCI state is applied to the aperiodic CSI-RS resource. For periodic or semi-persistent CSI-RS resource without configured or activated TCI state, the activated DL TCI state with the lowest index is applied for the periodic or semi-persistent CSI-RS resource, or the first DL TCI state activated to the lowest TCI codepoint that is activated with at least one DL TCI state is applied to the periodic or semi-persistent CSI-RS resource.

In some embodiment, the method further comprises receiving a capability on whether the indicated TCI state can be applied for CORESET with index 0 when SFN scheme is configured.

FIG. 4 is a schematic block diagram illustrating apparatuses according to one embodiment.

Referring to FIG. 4, the UE (i.e. the remote unit) includes a processor, a memory, and a transceiver. The processor implements a function, a process, and/or a method which are proposed in FIG. 2.

The UE comprises a transceiver; and a processor coupled to the transceiver, wherein the processor is configured to receive, via the transceiver, a medium access control (MAC) control element (CE) activating at least one Transmission Configuration Indication (TCI) codepoint with two downlink (DL) or joint TCI states; and receive, via the transceiver, a downlink control information (DCI) indicating one TCI codepoint being activated with two DL or joint TCI states if multiple TCI codepoints are activated with DL or joint TCI states.

In some embodiment, the processor is further configured to determine, for PDCCH reception, one of or both a first TCI state and a second TCI state of the two DL or joint TCI states activated to the only one activated TCI codepoint or the indicated one TCI codepoint. In particular, depending on CORESET ID of a CORESET for PDCCH reception and/or search space(s) associated with the CORESET, one of or both the first TCI state and the second TCI state are determined for PDCCH reception from the CORESET.

If SFN scheme is configured in a BWP of a cell, for CORESET with index 0, a configured higher layer parameter in the CORESET with index 0 indicates the first TCI state or the second TCI state or both the first TCI state and the second TCI state are applied to DMRS port of PDCCH from the CORESET with index 0, and if no higher layer parameter is configured to indicate the TCI state for PDCCH from the CORESET with index 0, a second MAC CE indicates one or two DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, both the first TCI state and the second TCI state are applied to the DMRS port of the PDCCH from the first CORESET with index other than 0; for a second CORESET with index other than 0 associated only with CSS other than Type3-PDCCH CSS sets, the first TCI state or both the first TCI state and the second TCI state are applied to the DMRS port of the PDCCH from the second CORESET with index other than 0; and for a third CORESET with index other than 0 associated with both USS and/or Type3-PDCCH CSS sets and CSS other than Type3-PDCCH CSS sets, both the first TCI state and the second TCI state are applied to the PDCCH in USS and/or Type3-PDCCH CSS sets from the third CORESET with index other than 0 and the first TCI state is applied to the PDCCH in CSS other than Type3-PDCCH CSS sets from the third CORESET with index other than 0, or both the first TCI state and the second TCI state are applied to the PDCCH in USS and/or Type3-PDCCH CSS sets from the third CORESET with index other than 0 and a configured higher layer parameter indicates the first TCI state or the second TCI state or both the first TCI state and the second TCI state are applied to DMRS port of PDCCH in CSS other than Type3-PDCCH CSS sets from the third CORESET with index other than 0, or a configured higher layer parameter for the third CORESET with index other than 0 indicates the first TCI state or the second TCI state or both the first TCI state and the second TCI state are applied to DMRS port of PDCCH from the third CORESET with index other than 0.

If SFN scheme is not configured in a BWP of a cell, for CORESET with index 0, a configured higher layer parameter for the CORESET with index 0 indicates the first TCI state or the second TCI state is applied to DMRS port of PDCCH from the CORESET with index 0, and if no higher layer parameter is configured to indicate the TCI state for PDCCH from the CORESET with index 0, a second MAC CE indicates one DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, the first TCI state is applied to the DMRS port of the PDCCH from the first CORESET with index other than 0, or a configured higher layer parameter indicates the first TCI state or the second TCI state is applied to the DMRS port of the PDCCH from the first CORESET with index other than 0; for a second CORESET with index other than 0 associated only with CSS other than Type3-PDCCH CSS sets, a configured higher layer parameter for the second CORESET indicates the first TCI state or the second TCI state is applied to the DMRS port of the PDCCH from the second CORESET with index other than 0, and if no higher layer parameter is configured to indicate the TCI state for PDCCH from the second CORESET with index other than 0, a second MAC CE indicates one DL TCI state for the second CORESET with index other than 0; and for a third CORESET with index other than 0 associated with both USS and/or Type3-PDCCH CSS sets and CSS other than Type3-PDCCH CSS sets, the first TCI state is applied to the DMRS port of the PDCCH in USS and/or Type3-PDCCH CSS sets from the third CORESET with index other than 0 and a configured higher layer parameter for the third CORESET indicates the first TCI state or the second TCI state is applied to the DMRS port of the PDCCH in CSS other than Type3-PDCCH CSS sets from the third CORESET with index other than 0, or a configured higher layer parameter for the third CORESET indicates the first TCI state or the second TCI state are applied to PDCCH from the third CORESET with index other than 0.

In some embodiment, the processor is further configured to determine, for CSI-RS resource without configured TCI state or QCL information, one activated TCI state. In particular, for aperiodic CSI-RS resource used for CSI acquisition and beam management, a configured higher layer parameter indicates a first TCI state or a second TCI state of the two DL or joint TCI states activated to the only one TCI codepoint or the indicated one TCI codepoint is applied to the aperiodic CSI-RS resource; and if no higher layer parameter is configured to indicate the TCI state for the aperiodic CSI-RS resource, the first TCI state is applied to the aperiodic CSI-RS resource. For periodic or semi-persistent CSI-RS resource without configured or activated TCI state, the activated DL TCI state with the lowest index is applied for the periodic or semi-persistent CSI-RS resource, or the first DL TCI state activated to the lowest TCI codepoint that is activated with at least one DL TCI state is applied to the periodic or semi-persistent CSI-RS resource.

In some embodiment, the processor is further configured to transmit, via the transceiver, a capability on whether the indicated TCI state can be applied for CORESET with index 0 when SFN scheme is configured.

The gNB (i.e. the base unit) includes a processor, a memory, and a transceiver. The processor implements a function, a process, and/or a method which are proposed in FIG. 3.

The base unit comprises a transceiver; and a processor coupled to the transceiver, wherein the processor is configured to transmit, via the transceiver, a medium access control (MAC) control element (CE) activating at least one Transmission Configuration Indication (TCI) codepoint with two downlink (DL) or joint TCI states; and transmit, via the transceiver, a downlink control information (DCI) indicating one TCI codepoint being activated with two DL or joint TCI states if multiple TCI codepoints are activated with DL or joint TCI states.

In some embodiment, the processor is further configured to determine, for PDCCH reception, one of or both a first TCI state and a second TCI state of the two DL or joint TCI states activated to the only one activated TCI codepoint or the indicated one TCI codepoint. In particular, depending on CORESET ID of a CORESET for PDCCH reception and/or search space(s) associated with the CORESET, one of or both the first TCI state and the second TCI state are determined for PDCCH reception from the CORESET.

If SFN scheme is configured in a BWP of a cell, for CORESET with index 0, a configured higher layer parameter in the CORESET with index 0 indicates the first TCI state or the second TCI state or both the first TCI state and the second TCI state are applied to DMRS port of PDCCH from the CORESET with index 0, and if no higher layer parameter is configured to indicate the TCI state for PDCCH from the CORESET with index 0, a second MAC CE indicates one or two DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, both the first TCI state and the second TCI state are applied to the DMRS port of the PDCCH from the first CORESET with index other than 0; for a second CORESET with index other than 0 associated only with CSS other than Type3-PDCCH CSS sets, the first TCI state or both the first TCI state and the second TCI state are applied to the DMRS port of the PDCCH from the second CORESET with index other than 0; and for a third CORESET with index other than 0 associated with both USS and/or Type3-PDCCH CSS sets and CSS other than Type3-PDCCH CSS sets, both the first TCI state and the second TCI state are applied to the PDCCH in USS and/or Type3-PDCCH CSS sets from the third CORESET with index other than 0 and the first TCI state is applied to the PDCCH in CSS other than Type3-PDCCH CSS sets from the third CORESET with index other than 0, or both the first TCI state and the second TCI state are applied to the PDCCH in USS and/or Type3-PDCCH CSS sets from the third CORESET with index other than 0 and a configured higher layer parameter indicates the first TCI state or the second TCI state or both the first TCI state and the second TCI state are applied to DMRS port of PDCCH in CSS other than Type3-PDCCH CSS sets from the third CORESET with index other than 0, or a configured higher layer parameter for the third CORESET with index other than 0 indicates the first TCI state or the second TCI state or both the first TCI state and the second TCI state are applied to DMRS port of PDCCH from the third CORESET with index other than 0.

If SFN scheme is not configured in a BWP of a cell, for CORESET with index 0, a configured higher layer parameter for the CORESET with index 0 indicates the first TCI state or the second TCI state is applied to DMRS port of PDCCH from the CORESET with index 0, and if no higher layer parameter is configured to indicate the TCI state for PDCCH from the CORESET with index 0, a second MAC CE indicates one DL TCI state for the CORESET with index 0, and if the second MAC CE is not received, the SSB obtained from the latest random access procedure is applied to the DMRS port of PDCCH from the CORESET with index 0; for a first CORESET with index other than 0 associated only with USS and/or Type3-PDCCH CSS sets, the first TCI state is applied to the DMRS port of the PDCCH from the first CORESET with index other than 0, or a configured higher layer parameter indicates the first TCI state or the second TCI state is applied to the DMRS port of the PDCCH from the first CORESET with index other than 0; for a second CORESET with index other than 0 associated only with CSS other than Type3-PDCCH CSS sets, a configured higher layer parameter for the second CORESET indicates the first TCI state or the second TCI state is applied to the DMRS port of the PDCCH from the second CORESET with index other than 0, and if no higher layer parameter is configured to indicate the TCI state for PDCCH from the second CORESET with index other than 0, a second MAC CE indicates one DL TCI state for the second CORESET with index other than 0; and for a third CORESET with index other than 0 associated with both USS and/or Type3-PDCCH CSS sets and CSS other than Type3-PDCCH CSS sets, the first TCI state is applied to the DMRS port of the PDCCH in USS and/or Type3-PDCCH CSS sets from the third CORESET with index other than 0 and a configured higher layer parameter for the third CORESET indicates the first TCI state or the second TCI state is applied to the DMRS port of the PDCCH in CSS other than Type3-PDCCH CSS sets from the third CORESET with index other than 0, or a configured higher layer parameter for the third CORESET indicates the first TCI state or the second TCI state are applied to PDCCH from the third CORESET with index other than 0.

In some embodiment, the processor is further configured to determine, for CSI-RS resource without configured TCI state or QCL information, one activated TCI state. In particular, for aperiodic CSI-RS resource used for CSI acquisition and beam management, a configured higher layer parameter indicates a first TCI state or a second TCI state of the two DL or joint TCI states activated to the only one TCI codepoint or the indicated one TCI codepoint is applied to the aperiodic CSI-RS resource; and if no higher layer parameter is configured to indicate the TCI state for the aperiodic CSI-RS resource, the first TCI state is applied to the aperiodic CSI-RS resource. For periodic or semi-persistent CSI-RS resource without configured or activated TCI state, the activated DL TCI state with the lowest index is applied for the periodic or semi-persistent CSI-RS resource, or the first DL TCI state activated to the lowest TCI codepoint that is activated with at least one DL TCI state is applied to the periodic or semi-persistent CSI-RS resource.

In some embodiment, the processor is further configured to receive, via the transceiver, a capability on whether the indicated TCI state can be applied for CORESET with index 0 when SFN scheme is configured.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a medium access control (MAC) control element (CE) activating at least one Transmission Configuration Indication (TCI) codepoint with two downlink (DL) or joint TCI states; and
receive a downlink control information (DCI) indicating one TCI codepoint being activated with two DL or joint TCI states if multiple TCI codepoints are activated with DL or joint TCI states.

2. The UE of claim 1, wherein the at least processor is further configured to cause the UE to: determine, for physical downlink control channel (PDCCH) reception, one or both of a first TCI state and a second TCI state of the two DL or joint TCI states activated to the only one activated TCI codepoint or the indicated one TCI codepoint.

3. The UE of claim 2, wherein the at least one processor is further configured to cause the UE to determine the one or both of the first TCI state and the second TCI state from a CORESET based on a CORESET ID of the CORESET for the PDCCH reception or based on search spaces associated with the CORESET.

4. The UE of claim 3, wherein, if a system frame number (SFN) scheme is configured in a bandwidth part (BWP) of a cell,
for CORESET with index 0, a configured higher layer parameter in the CORESET with index 0 indicates the first TCI state or the second TCI state or both the first TCI state and the second TCI state are applied to a demodulation reference signal (DMRS) port of PDCCH from the CORESET with index 0, and if no higher layer parameter is configured to indicate the TCI state for PDCCH from the CORESET with index 0, a second MAC CE indicates one or two DL TCI states for the CORESET with index 0, and if the second MAC CE is not received, the synchronization signal block (SSB) obtained from a latest random access procedure is applied to the DMRS port of PDCCH from the CORESET with index 0;
for a first CORESET with index other than 0 associated only with UE specific search space (USS) and/or Type3-PDCCH common search space (CSS) sets, both the first TCI state and the second TCI state are applied to the DMRS port of the PDCCH from the first CORESET with index other than 0;
for a second CORESET with index other than 0 associated only with CSS other than Type3-PDCCH CSS sets, the first TCI state or both the first TCI state and the second TCI state are applied to the DMRS port of the PDCCH from the second CORESET with index other than 0; and
for a third CORESET with index other than 0 associated with both USS and/or Type3-PDCCH CSS sets and CSS other than Type3-PDCCH CSS sets, both the first TCI state and the second TCI state are applied to the PDCCH in USS and/or Type3-PDCCH CSS sets from the third CORESET with index other than 0 and the first TCI state is applied to the PDCCH in CSS other than Type3-PDCCH CSS sets from the third CORESET with index other than 0, or both the first TCI state and the second TCI state are applied to the PDCCH in USS and/or Type3-PDCCH CSS sets from the third CORESET with index other than 0 and a configured higher layer parameter indicates the first TCI state or the second TCI state or both the first TCI state and the second TCI state are applied to DMRS port of PDCCH in CSS other than Type3-PDCCH CSS sets from the third CORESET with index other than 0, or a configured higher layer parameter for the third CORESET with index other than 0 indicates the first TCI state or the second TCI state or both the first TCI state and the second TCI state are applied to DMRS port of PDCCH from the third CORESET with index other than 0.

5. The UE of claim 3, wherein, if a system frame number (SFN) scheme is not configured in a bandwidth part (BWP) of a cell,
for CORESET with index 0, a configured higher layer parameter for the CORESET with index 0 indicates the first TCI state or the second TCI state is applied to a demodulation reference signal (DMRS) port of PDCCH from the CORESET with index 0, and if no higher layer parameter is configured to indicate the TCI state for PDCCH from the CORESET with index 0, a second MAC CE indicates one DL TCI state for the CORESET with index 0, and if the second MAC CE is not received, the SSB obtained from the latest random access procedure is applied to the DMRS port of PDCCH from the CORESET with index 0;
for a first CORESET with index other than 0 associated only with a UE specific search space (USS) and/or Type3-PDCCH common search space (CSS) sets, the first TCI state is applied to the DMRS port of the PDCCH from the first CORESET with index other than 0, or a configured higher layer parameter indicates the first TCI state or the second TCI state is applied to the DMRS port of the PDCCH from the first CORESET with index other than 0;
for a second CORESET with index other than 0 associated only with CSS other than Type3-PDCCH CSS sets, a configured higher layer parameter for the second CORESET indicates the first TCI state or the second TCI state is applied to the DMRS port of the PDCCH from the second CORESET with index other than 0, and if no higher layer parameter is configured to indicate the TCI state for PDCCH from the second CORESET with index other than 0, a second MAC CE indicates one DL TCI state for the second CORESET with index other than 0; and
for a third CORESET with index other than 0 associated with both USS and/or Type3-PDCCH CSS sets and CSS other than Type3-PDCCH CSS sets, the first TCI state is applied to the DMRS port of the PDCCH in USS and/or Type3-PDCCH CSS sets from the third CORESET with index other than 0 and a configured higher layer parameter for the third CORESET indicates the first TCI state or the second TCI state is applied to the DMRS port of the PDCCH in CSS other than Type3-PDCCH CSS sets from the third CORESET with index other than 0, or a configured higher layer parameter for the third CORESET indicates the first TCI state or the second TCI state are applied to PDCCH from the third CORESET with index other than 0.

6. The UE of claim 1, wherein the at least one processor is further configured to cause the UE to: determine, for a channel state information reference signal (CSI-RS) resource without a configured TCI state or QCL information, one activated TCI state.

7. The UE of claim 6, wherein, for an aperiodic CSI-RS resource used for CSI acquisition and beam management, a configured higher layer parameter indicates a first TCI state or a second TCI state of the two DL or joint TCI states activated to the only one TCI codepoint or the indicated one TCI codepoint is applied to the aperiodic CSI-RS resource; and if no higher layer parameter is configured to indicate the TCI state for the aperiodic CSI-RS resource, the first TCI state is applied to the aperiodic CSI-RS resource.

8. The UE of claim 6, wherein, for a periodic or a semi-persistent CSI-RS resource without configured or activated TCI state, the activated DL TCI state with the lowest index is applied for the periodic or semi-persistent CSI-RS resource, or the first DL TCI state activated to the lowest TCI codepoint that is activated with at least one DL TCI state is applied to the periodic or semi-persistent CSI-RS resource.

9. The UE of claim 1, wherein the at least one processor is further configured to cause the UE to: transmit a capability on whether the indicated TCI state can be applied for CORESET with index 0 when a system frame number (SFN) scheme is configured.

10. A method performed by a user equipment (UE), the method comprising:
receiving a medium access control (MAC) control element (CE) activating at least one Transmission Configuration Indication (TCI) codepoint with two downlink (DL) or joint TCI states; and
receiving a downlink control information (DCI) indicating one TCI codepoint being activated with two DL or joint TCI states if multiple TCI codepoints are activated with DL or joint TCI states.

11. A base unit for wireless communication, comprising:
at least one memory; and
at least one processor coupled with the at least one memory and configured to cause the base unit to:
transmit a medium access control (MAC) control element (CE) activating at least one Transmission Configuration Indication (TCI) codepoint with two downlink (DL) or joint TCI states; and
transmit a downlink control information (DCI) indicating one TCI codepoint being activated with two DL or joint TCI states if multiple TCI codepoints are activated with DL or joint TCI states.

12. The base unit of claim 11, wherein the at least processor is further configured to cause the UE to: determine, for physical downlink control channel (PDCCH) reception, one or both of a first TCI state and a second TCI state of the two DL or joint TCI states activated to the only one activated TCI codepoint or the indicated one TCI codepoint.

13. The base unit of claim 12, wherein the at least one processor is further configured to cause the base unit to determine the one or both of the first TCI state and the second TCI state from a CORESET based on a CORESET ID of the CORESET for the PDCCH reception or based on search spaces associated with the CORESET.

14. The base unit of claim 11, wherein the at least one processor is further configured to cause the base unit to determine, for a channel state information reference signal (CSI-RS) resource without a configured TCI state or QCL information, one activated TCI state.

15. The base unit of claim 11, wherein the at least one processor is further configured to cause the base unit to receive a capability on whether the indicated TCI state can be applied for a CORESET with index 0 when a system frame number (SFN) scheme is configured.

16. A processor for wireless communication, comprising:
at least one controller coupled with the at least one memory and configured to cause the processor to:
receive a medium access control (MAC) control element (CE) activating at least one Transmission Configuration Indication (TCI) codepoint with two downlink (DL) or joint TCI states; and
receive a downlink control information (DCI) indicating one TCI codepoint being activated with two DL or joint TCI states if multiple TCI codepoints are activated with DL or joint TCI states.

17. The processor of claim 16, wherein the at least controller is further configured to cause the processor to: determine, for physical downlink control channel (PDCCH) reception, one or both of a first TCI state and a second TCI state of the two DL or joint TCI states activated to the only one activated TCI codepoint or the indicated one TCI codepoint.

18. The processor of claim 16, wherein the at least one controller is further configured to cause the processor to determine the one or both of the first TCI state and the second TCI state from a CORESET based on a CORESET ID of the CORESET for the PDCCH reception or based on search spaces associated with the CORESET.

19. The processor of claim 16, wherein the at least one controller is further configured to cause the processor to: determine, for a channel state information reference signal (CSI-RS) resource without a configured TCI state or QCL information, one activated TCI state.

20. The processor of claim 16, wherein the at least one controller is further configured to cause the processor to: transmit a capability on whether the indicated TCI state can be applied for CORESET with index 0 when a system frame number (SFN) scheme is configured.
